(19) United States
(12) Patent Application Publication
(10) Pub. No.: US 2026/0212652 A1
(43) Pub. Date: Jul. 23, 2026

(54) SYSTEM AND METHOD FOR IMPROVING IMAGE DATA COVERAGE IN TRAFFIC SCENES USING ADAPTIVE BIN-BASED LATENT SPACE SAMPLING

(71) Applicant: Torc Robotics, Inc., Blacksburg, VA (US)

(72) Inventors: Juncong Fei, Stuttgart (DE); Siddharth Ramrakhiani, Tuebingen (DE); Lei Ge, Stuttgart (DE); Dalong Li, Troy, MI (US)

(21) Appl. No.: 19/034,840

(22) Filed: Jan. 23, 2025

(51) Int. Cl. G06V 10/774; G06V 10/25; G06V 10/32; G06V 20/58; G06V 20/70

(52) U.S. Cl. CPC G06V 10/774; G06V 10/25; G06V 10/32; G06V 20/58; G06V 20/70

(57) ABSTRACT

A system is disclosed to: (i) identify a distribution of a first set of datapoints corresponding to a first plurality of objects, of a current training dataset, in a grid including a plurality of bins; (ii) identify a second plurality of objects from an image of a plurality of images of received image data; (iii) identify one or more bins of the plurality of bins associated with a second set of datapoints corresponding to the second plurality of objects; (iv) for each bin, compute a respective sampling weight based upon the first set of datapoints and the second set of datapoints; (v) identify a bin having the respective sampling weight that satisfies a particular criterion; and (vi) add one or more objects of the second plurality of objects having corresponding datapoints of the second set of datapoints to the bin and add the image to the current training dataset.

### TECHNICAL FIELD

The field of the disclosure relates generally to training dataset for perception technologies used by an autonomous vehicle, more specifically, improving image data coverage in traffic scenes using adaptive bin-based latent space sampling.

### BACKGROUND OF THE INVENTION

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

Perception technologies use machine learning algorithms trained using a dataset, or training data. However, if the dataset used for training machine learning algorithms is not diverse enough, then the machine learning algorithms trained using such dataset may impair performance and may introduce a safety risk to the autonomous vehicle.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, a system including at least one memory configured to store machine executable instructions, and at least one processor coupled to the at least one memory and configured to execute the machine executable instructions is disclosed. The at least one processor, when executed the machine executable instructions, causes the at least one processor to: (i) process a current training dataset, including a first plurality of images, to identify a first plurality of objects; (ii) identify a distribution of a first set of datapoints corresponding to the first plurality of objects in a grid including a plurality of bins; (iii) receive image data including a second plurality of images; (iv) identify a second plurality of objects from an image of the second plurality of images; (v) identify one or more bins of the plurality of bins associated with a second set of datapoints corresponding to the second plurality of objects; (vi) for each bin of the plurality of bins, compute a respective sampling weight based upon the first set of datapoints and the second set of datapoints; (vii) identify a bin, of the plurality of bins, having the respective sampling weight that satisfies a particular criterion; and (viii) add one or more objects of the second plurality of objects having corresponding datapoints of the second set of datapoints to the bin and add the image from the second plurality of images to the current training dataset, thereby generating an improved training dataset.

In another aspect, a computer-implemented method is disclosed. The computer-implemented method includes (i) processing a current training dataset, including a first plurality of images, to identify a first plurality of objects; (ii) identifying a distribution of a first set of datapoints corresponding to the first plurality of objects in a grid including a plurality of bins; (iii) receiving image data including a second plurality of images; (iv) identifying a second plurality of objects from an image of the second plurality of images; (v) identifying one or more bins of the plurality of bins associated with a second set of datapoints corresponding to the second plurality of objects; (vi) for each bin of the plurality of bins, computing a respective sampling weight based upon the first set of datapoints and the second set of datapoints; (vii) identifying a bin, of the plurality of bins, having the respective sampling weight that satisfies a particular criterion; and (viii) adding one or more objects of the second plurality of objects having corresponding datapoints of the second set of datapoints to the bin and add the image from the second plurality of images to the current training dataset, thereby generating an improved training dataset.

In yet another aspect, a non-transitory computer-readable media including machine executable instructions stored thereon is disclosed. The machine executable instructions, which, when executed by at least one processor of a computing device, cause the computing device to: (i) process a current training dataset, including a first plurality of images, to identify a first plurality of objects; (ii) identify a distribution of a first set of datapoints corresponding to the first plurality of objects in a grid including a plurality of bins; (iii) receive image data including a second plurality of images; (iv) identify a second plurality of objects from an image of the second plurality of images; (v) identify one or more bins of the plurality of bins associated with a second set of datapoints corresponding to the second plurality of objects; (vi) for each bin of the plurality of bins, compute a respective sampling weight based upon the first set of datapoints and the second set of datapoints; (vii) identify a bin, of the plurality of bins, having the respective sampling weight that satisfies a particular criterion; and (viii) add one or more objects of the second plurality of objects having corresponding datapoints of the second set of datapoints to the bin and add the image from the second plurality of images to the current training dataset, thereby generating an improved training dataset.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1. is a schematic view of an autonomous truck;

FIG. 2 is a block diagram of the autonomous truck shown in FIG. 1;

FIG. 3 is a block diagram of an example computing system;

FIG. 4 is a graph illustrating an example distribution of latent space features of various objects in a feature space;

FIG. 5 is a graph illustrating an example distribution of objects in a current training dataset;

FIG. 6 is a graph illustrating an example distribution of objects in the current training dataset with new objects detected from new image data; and

FIG. 7 is a flow-chart of an example method of enhancing or improving a current training dataset used for training a machine learning algorithm for perception technologies.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

Some structural or method features may be shown in specific arrangements and/or orderings in the drawings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments, and, in some embodiments, it may not be included or may be combined with other features.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

One or more of the following terms may be used in the disclosure, and their definition is provided below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

An ego vehicle: An ego vehicle is a vehicle equipped with sensors such as, one or more camera sensors, one or more light detection and ranging (LiDAR) sensors, one or more radio detection and ranging (RADAR) sensors, etc., for collecting sensor data for various purposes including, but not limited to, training, testing, or validation.

A feature space: A feature space is a multi-dimensional space representing all possible values of features or variables describing a dataset. Each feature or variable represents a dimension, and each data point is a unique point in the feature space represented by coordinates of the data point corresponding to the values of the features.

A latent space: A latent space, as described herein, serves as a representation for capturing a diverse range of object variations encountered in real-world scenarios. Based on the unique characteristics of the latent space, the latent space may be used as a classifier or a supervised predictor for a machine learning algorithm. The latent space is therefore a lower-dimensional feature space capturing essential features of input data.

As described herein, high-quality data is the key to data-centric artificial intelligence (AI) based machine learning algorithms. AI based machine learning algorithms are sometimes used for perception technologies. Machine learning algorithms trained using a dataset including diverse data objects may significantly improve performance of the perception technologies by reliably identifying many different types of objects from sensor data. The sensor data, for example, may be collected using one or more camera sensors.

Generally, machine learning algorithms are trained using a training dataset that is generally available from third parties. Various embodiments described herein enhance the training dataset using image data collected by one or more ego vehicles. In particular, image data may be analyzed to identify image data associated with traffic scenes that enhance a current training dataset by improving diversity of image objects that are present in the training dataset.

The disclosed systems and methods enhance or improve the training dataset using an adaptive bin-based latent space sampling. The diversity of an image is computed based upon a number of different objects present in the image. For example, an image consisting of many pedestrians is “different” compared to an image consisting of many cars. Accordingly, to enhance or improve the training dataset, images including as many different, or diverse, objects are employed. The image is processed to cluster objects in latent space using a deep neural network. The deep neural network, which is trained via contrastive pre-training, learns to embed similar objects close to each other, and vice-versa. In contrastive pre-training, model weights are initialized for efficient fine-tuning of the deep neural network to downstream tasks. Further, using contrastive learning, the performance of vision tasks is enhanced by using the principle of contrasting objects against each other to learn attributes that are common between data classes and attributes that set apart a data class from another. Based on the contrastive learning, similar objects are grouped or embedded together.

In an example embodiment, the adaptive bin-based latent space sampling includes three stages. A first stage includes computing latent space features of each object included in the current training dataset. The current training dataset may include image data of a plurality of images. A distribution of all objects in the current training dataset is obtained and represented in a grid. A second stage includes processing new image data, collected by one or more ego vehicles, to detect objects using an image two-dimensional (2D) object detector and compute latent space features for one or more detected 2D objects. A third stage includes, based on a comparison of the latent space features obtained during the first stage with the latent space features obtained during the second stage, selecting new objects and corresponding images including the selected new objects in the training dataset. The training dataset is thus enhanced or improved by adding the new images including new objects. The improved training dataset can then be used for training perception technologies machine learning algorithms and improves object detection performance and safety of the autonomous vehicle.

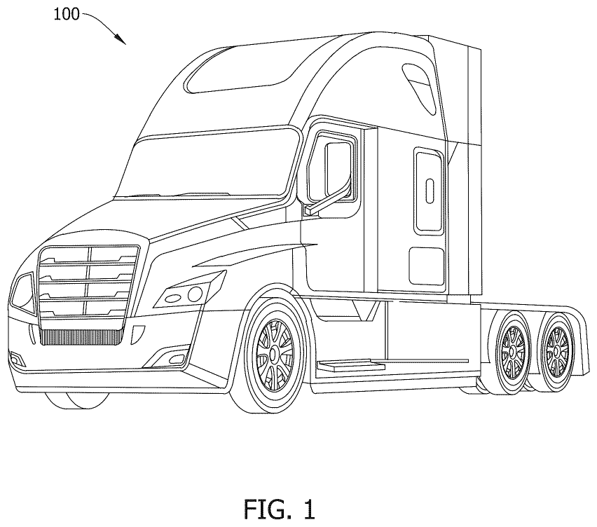

FIG. 1 illustrates a vehicle 100, such as a truck that may be conventionally connected to a single or tandem trailer to transport the trailer (not shown in FIG. 1) to a desired location. The vehicle 100 includes a cabin that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of cabin.

The vehicle 100 may be an autonomous vehicle, in which case the vehicle 100 may omit the steering wheel and the steering column to steer the vehicle 100. Rather, the vehicle 100 may be operated by an autonomy computing system (not shown in FIG. 1) of the vehicle 100 based on data collected by a sensor network (not shown in FIG. 1) including one or more sensors. The vehicle 100 may be an ego vehicle referenced herein.

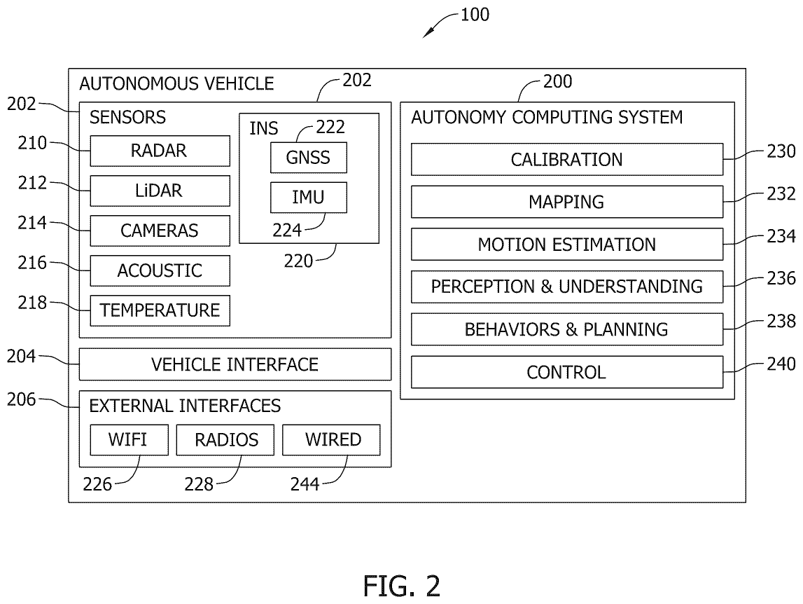

FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, and navigation sensors. Navigation sensors, as described herein, may be one or more inertial navigation system (INS) sensors (or systems) 220, one or more global navigation satellite system (GNSS) sensors 222, or one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers or other objects in the environment surrounding autonomous vehicle 100. In some embodiments, the image data generated by cameras 214 may be sent to autonomy computing system 200 or other aspects of autonomous vehicle 100 or mission control (a hub) or both.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment. Additionally, or alternatively, GNSS receiver 222 may be configured to receive RTK and GNSS position information from satellite-based systems.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5G, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, and a control module or controller 240. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

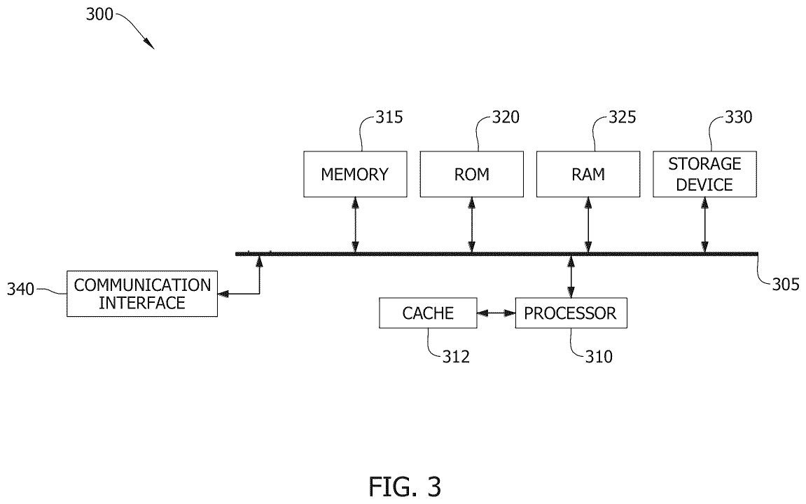

FIG. 3 illustrates an example computing system 300 that can implement various techniques, processes, functions, or methods described herein. Computing system 300 may be embodied within, for example, autonomous vehicle 100 shown in FIG. 1. The components of computing system 300 are shown in electrical communication with each other using a connection 305, such as a bus. The example computing system 300 includes a processing unit (CPU or processor) 310 and a computing device connection 305 that couples various computing device components, including computing device memory 315, such as a read only memory (ROM) 320 and a random-access memory (RAM) 325, to processor 310.

The processor 310 may be communicatively coupled with a communication interface 340 to communicate with external entities such as, mission control, or one or more other vehicles using V2V communication. Accordingly, the communication interface 340 may include one or more of a radio interface, an electronic sign board mounted on autonomous vehicle 100, a public address system or a loudspeaker positioned at autonomous vehicle 100. The radio interface may be configured for at least one of: (i) a vehicle-to-vehicle communication technique, (ii) citizens band radio frequencies; (iii) a Bluetooth signal; and (iv) a short message service (SMS) technology.

Computing system 300 can include a cache 312 of high-speed memory connected directly with, in close proximity to, or integrated as part of processor 310. Computing system 300 can copy data from memory 315 and/or storage device 330 to cache 312 for quick access by processor 310. In this way, cache 312 can provide a performance boost that avoids processor 310 delays while waiting for data. These and other modules can control or be configured to control processor 310 to perform various actions. Other computing device memory 315 may be available for use as well. Memory 315 can include multiple different types of memory with different performance characteristics. Processor 310 can include any general-purpose processor, central processing unit (CPU), or graphics processing unit (GPU) in combination with a hardware or software provision configured to control processor 310 and stored in storage device 330, as well as any special-purpose processor where software instructions are incorporated into the processor design. Processor 310 may be a self-contained system, containing multiple cores or processors, a bus, memory controller, cache, etc. A multi-core processor may be symmetric or asymmetric.

Storage device 330 is a non-volatile memory and can be one or more of a hard disk or other types of computer readable media that can store data that are accessible by a computer, such as a magnetic cassette, flash memory card, solid state memory device, digital versatile disk, cartridge, RAM 325, ROM 320, or hybrids thereof. Memory 315 or storage device 330 can include software, code, firmware, etc., for controlling processor 310. Other hardware or software modules are contemplated. Memory 315 and storage device 330 are connected to computing device connection 305. In one aspect, a hardware module that performs a particular function can include the software component stored in a computer-readable medium in connection with the necessary hardware components, such as processor 310, computing device connection 305, and so forth, to carry out the function. In the example embodiment, processor 310 may be programmed by encoding an operation or function using one or more executable instructions and providing the executable instructions in memory 315 or storage device 330.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

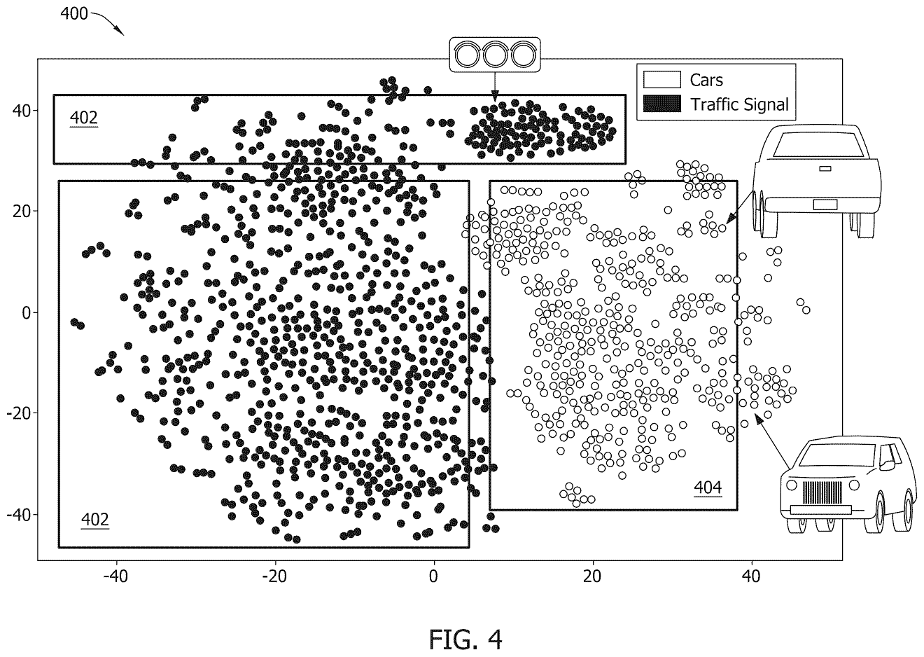

FIG. 4 is a graph illustrating an example distribution 400 of latent space features of various objects in a feature space. The latent space features, as described herein, represent a lower-dimensional feature space capturing essential features of input data. In particular, in FIG. 4, high-dimensional latent space features of each image object are displayed in a 2D plot after dimensionality reduction (e.g., from a three or more dimensions to two dimensions). By way of an example, a first set of datapoints 402 represents traffic signal objects, while a second set of datapoints 404 represents car objects. Based upon the distribution of latent space features, as shown in FIG. 4, various image objects are generally considered as being clustered at different locations in the feature space.

As described herein, the current training dataset is enhanced or improved using a method for an adaptive bin-based latent space sampling. The method includes three stages-a first stage, a second stage, and a third stage-described in detail below. The first stage includes obtaining a distribution of objects in latent space from the current training dataset. During the second stage, an image 2D object detector is employed or used to detect objects and compute latent space features for a newly recorded image data. During the third stage, based on the distribution obtained in the first stage and the second stage, new objects and later the images including the selected new objects are selected to be added in the training dataset.

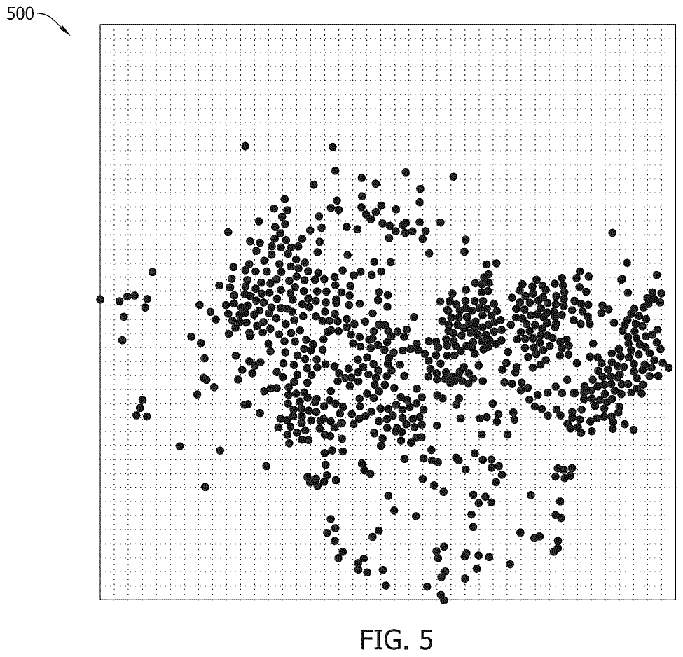

FIG. 5 is a graph illustrating an example distribution of objects in the current training dataset in a grid 500. The current training dataset may include a plurality of images. The plurality of images may include images with annotated object labels or images without annotated object labels. For the images with annotated object labels, ground-truth 2D object labels are used to crop 2D image objects. For other images such as, images without object labels, a deep neural network trained and configured for object detection is used to identify or detect bounding boxes of various objects in an image. Further, the bounding boxes are only needed for detection, and objects within the bounding boxes are not required for classification.

Each cropped bounding box is provided as an input to a large image Foundation Model to extract high-dimensional latent space features. By way of an example, the large image Foundation Model may be a deep neural network (DNN) based image foundation model (FMDNN) such as, Generative Pre-Trained Transformer 4 (GPT-4), or a self-supervised vision transformer model (e.g. DIstillation of knowledge with No labels and vIsion transformers 2 (DINOv2), ImageBind, etc.). For each object, dimensions of the high-dimensional latent space features obtained using the FMDNN may be reduced to two dimensional (2D) features using techniques like t-distributed Stochastic Neighbor Embedding (t-SNE), or Uniform Manifold Approximation and Projection (UMAP), etc. Each object thereby reduced to 2D features may be represented as a datapoint on the grid 500.

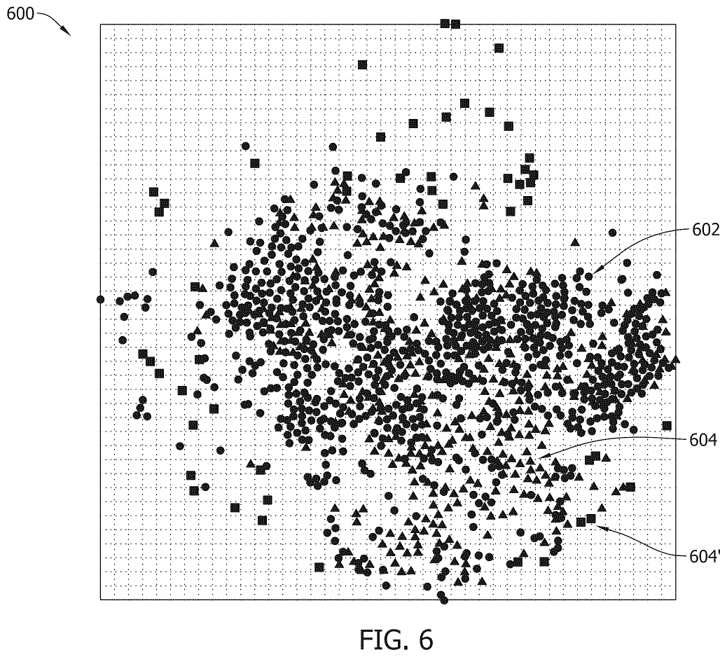

FIG. 6 is a graph illustrating an example distribution of objects 602 in the current training dataset with new objects 604 detected from new image data added to a grid 600. The new objects 604 are detected during the second stage by processing new image data collected by the one or more ego vehicles. The new image data is processed to detect objects using an image 2D object detector. Examples of the image 2D object detector include, but not limited to, You Only Look Once (YOLO), Single Shot MultiBox Detector (SSD), Faster Region-based Convolutional Neural Network (R-CNN), or RetinaNet, etc. Detected 2D objects are then cropped. In particular, a 2D object is cropped to highlight specific features of the 2D object.

Each cropped object (or bounding box) is provided as an input to the large image Foundation Model to extract high-dimensional latent space features from each cropped object. For each cropped object, dimensions of the high-dimensional latent space features obtained using the FMDNN may be reduced to 2D features using techniques like t-SNE, or UMAP, etc. Each cropped object may be thereby reduced to 2D features and may be added as a datapoint on the grid 600 along with datapoints corresponding to the objects in the existing training dataset.

The grid 500 shown in FIG. 5 and the grid 600 shown in FIG. 6 each includes a plurality of bins, and illustrates an object distribution. Each box in the grid 500 or grid 600 corresponds to a bin of the plurality of bins. Accordingly, each bin represents objects having certain characteristics or having common characteristics. An empty bin therefore suggests that no objects are present in the training dataset representing those characteristics associated with the bin. And many objects in the bin therefore suggest that there are likely sufficient diverse objects present in the training dataset representing those characteristics associated with the bin.

As described herein, the third stage includes, based on a comparison of the latent space features obtained during the first stage with the latent space features obtained during the second stage, selecting new objects and corresponding images including the selected new objects in the training dataset.

As shown in FIG. 6, new objects added to the grid in their respective bins may already have objects in the bins. Consequently, adding new objects may not always enhance the existing training dataset. However, the existing training dataset may be enhanced by adding new objects to bins that either do not have objects present in the bins or have comparatively few objects. Accordingly, adding new objects selectively may enhance or improve the training dataset.

For each bin of the grid, a sampling weight is calculated using Eq. 1, as shown below.

$$\frac{1}{( N 1 + ε ) + ( N 2 + ε )} , \qquad Eq . 1$$

In Eq. 1 above, N1 represents a number of datapoints corresponding to objects from the existing training dataset, N2 represents a number of datapoints corresponding to new objects from the new image data, and ε corresponds to a value close to 0 but greater than 0, e.g., 0.1, to avoid division by 0. Accordingly, (N1+ε) ensures a lower probability of selecting new objects from the new image data if there are already many existing datapoints in a particular bin, and (N2+ε) ensures a lower probability of selecting multiple new objects from the new image data if there are many new datapoints in the particular bin.

In an example embodiment, the new datapoints are selected by sampling using the sampling weight calculated using the above formula. A datapoint with a higher sampling weight has a higher probability of being selected. In other words, new datapoints are sampled and selected instead of bins. The selected new datapoints are distinguishably shown in FIG. 6 as 604′. Such sampling avoids selecting too many points from regions that (1) already contain a plurality of points from the existing dataset and (2) already contain a lot of points from the newly recorded image dataset. This ensures the coverage of sampling is increased, thereby promoting diversity of selected objects. The images from the new image data corresponding to the selected new datapoints are added to the existing training dataset to improve or enhance the training dataset. The improved training dataset thereby improves object detection performance using the machine learning algorithm trained with that data and improves safety of the autonomous vehicle.

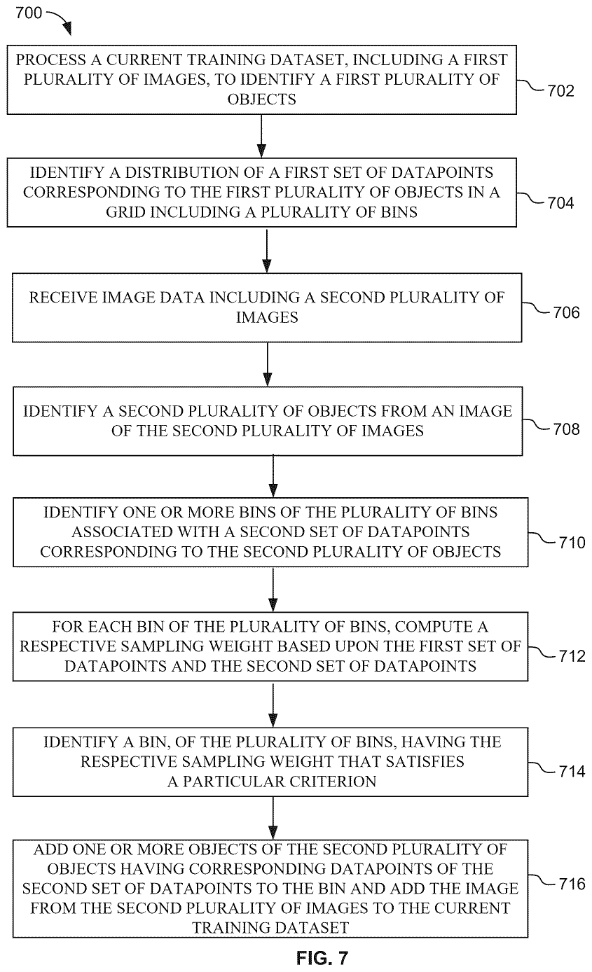

FIG. 7 is a flow-chart of an example method 700 of enhancing or improving training dataset used for training a machine learning algorithm of perception technologies. The method may be embodied in a server, e.g., located at mission control, a manufacturing hub, or a maintenance hub, based upon image data collected by one or more ego vehicles using one or more camera sensors and transmitted to the server. The manufacturing hub or maintenance hub may receive sensor data and generate training dataset for various purposes including described herein. The method operations include processing 702 a current training dataset. The current training dataset includes a first plurality of images and is processed to identify a first plurality of objects, as described herein. An object of the first plurality of objects is identified using an annotated object label of an image of the first plurality of images. The method operations include identifying 704 a distribution of a first set of datapoints corresponding to the first plurality of objects in a grid. As described herein, the grid includes a plurality of bins.

The method operations include receiving 706 image data including a second plurality of images. The image data may be received from an ego vehicle mounted with a plurality of sensors, for example, image sensors. The method operations include identifying 708 a second plurality of objects from an image of the second plurality of images. Further, an object of the second plurality of objects is identified using a two-dimensional object detector algorithm. The method operations include identifying 710 one or more bins of the plurality of bins associated with a second set of datapoints corresponding to the second plurality of objects.

The method operations include, for each bin of the plurality of bins, computing 712 a respective sampling weight based upon the first set of datapoints and the second set of datapoints, and identifying 714 a bin, of the plurality of bins, having the respective sampling weight that satisfies a particular criterion. The particular criterion is dynamically determined based upon a value of N1 and a value of N2, described herein with regards to Eq. 1. In particular, the sampling weight is dynamically determined based upon the new data, i.e., N2 representing a number of datapoints corresponding to new objects from the new image data.

The respective sampling weight is computed using a formula that generates a lower value of the respective sampling weight for a larger number of datapoints in the first set of datapoints or the second set of datapoints. The method operations include adding 716 one or more objects of the second plurality of objects having corresponding datapoints of the second set of datapoints to the bin and add the image from the second plurality of images to the current training dataset, thereby generating an improved training dataset.

Further, the method operations may also include identifying a bounding box corresponding to an object of the first plurality of objects or the second plurality of objects and inputting the bounding box corresponding to the object to a large image foundation model to identify high-dimensional latent space features. Dimensionality of the high-dimensional latent space features is reduced using a dimensionality reduction algorithm to two-dimensional features and obtaining a datapoint corresponding the two-dimensional features of the object. By way of an example, the dimensionality reduction algorithm includes a t-distributed Stochastic Neighbor Embedding (t-SNE) algorithm or a Uniform Manifold Approximation and Projection (UMAP) algorithm.

An example technical effect of the methods, systems, and apparatus described herein includes at least availability of improved or enhanced training dataset with diverse objects for training machine learning algorithms for perception technologies.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a program, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random-access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein, including the implementation or utilization of components of the systems or steps independently and separately from other described components or steps. Therefore, it is manifestly intended that embodiments described herein be limited only by the claims.

What is claimed is:

1. A system comprising:
at least one memory configured to store machine executable instructions; and
at least one processor coupled to the at least one memory and configured to execute the machine executable instructions to:
process a current training dataset, including a first plurality of images, to identify a first plurality of objects;
identify a distribution of a first set of datapoints corresponding to the first plurality of objects in a grid including a plurality of bins;
receive image data including a second plurality of images;
identify a second plurality of objects from an image of the second plurality of images;
identify one or more bins of the plurality of bins associated with a second set of datapoints corresponding to the second plurality of objects;
for each bin of the plurality of bins, compute a respective sampling weight based upon the first set of datapoints and the second set of datapoints;
identify a bin, of the plurality of bins, having the respective sampling weight that satisfies a particular criterion; and
add one or more objects of the second plurality of objects having corresponding datapoints of the second set of datapoints to the bin and add the image from the second plurality of images to the current training dataset, thereby generating an improved training dataset.

2. The system of claim 1, wherein the respective sampling weight is computed using a formula that generates a lower value of the respective sampling weight for a larger number of datapoints in the first set of datapoints or the second set of datapoints.

3. The system of claim 1, wherein an object of the second plurality of objects is identified using a two-dimensional object detector algorithm.

4. The system of claim 1, wherein the at least one processor is further configured to execute the machine executable instructions to:
identify a bounding box corresponding to an object of the first plurality of objects or the second plurality of objects;
input the bounding box corresponding to the object to a large image foundation model to identify high-dimensional latent space features;
reduce dimensionality of the high-dimensional latent space features using a dimensionality reduction algorithm to two-dimensional features; and
obtain a datapoint corresponding the two-dimensional features of the object.

5. The system of claim 4, wherein the dimensionality reduction algorithm includes a t-distributed Stochastic Neighbor Embedding (t-SNE) algorithm or a Uniform Manifold Approximation and Projection (UMAP) algorithm.

6. The system of claim 1, wherein the image data is received from an ego vehicle based on sensor data from at least one image sensor positioned at the ego vehicle.

7. The system of claim 1, wherein an object of the first plurality of objects is identified using an annotated object label of an image of the first plurality of images.

8. A computer-implemented method comprising:
processing a current training dataset, including a first plurality of images, to identify a first plurality of objects;
identifying a distribution of a first set of datapoints corresponding to the first plurality of objects in a grid including a plurality of bins;
receiving image data including a second plurality of images;
identifying a second plurality of objects from an image of the second plurality of images;
identifying one or more bins of the plurality of bins associated with a second set of datapoints corresponding to the second plurality of objects;
for each bin of the plurality of bins, computing a respective sampling weight based upon the first set of datapoints and the second set of datapoints;
identifying a bin, of the plurality of bins, having the respective sampling weight that satisfies a particular criterion; and
adding one or more objects of the second plurality of objects having corresponding datapoints of the second set of datapoints to the bin and add the image from the second plurality of images to the current training dataset, thereby generating an improved training dataset.

9. The computer-implemented method of claim 8, wherein the respective sampling weight is computed using a formula that generates a lower value of the respective sampling weight for a larger number of datapoints in the first set of datapoints or the second set of datapoints.

10. The computer-implemented method of claim 8, wherein an object of the second plurality of objects is identified using a two-dimensional object detector algorithm.

11. The computer-implemented method of claim 8, further comprising:
identifying a bounding box corresponding to an object of the first plurality of objects or the second plurality of objects;
inputting the bounding box corresponding to the object to a large image foundation model to identify high-dimensional latent space features;
reducing dimensionality of the high-dimensional latent space features using a dimensionality reduction algorithm to two-dimensional features; and
obtaining a datapoint corresponding the two-dimensional features of the object.

12. The computer-implemented method of claim 11, wherein the dimensionality reduction algorithm includes a t-distributed Stochastic Neighbor Embedding (t-SNE) algorithm or a Uniform Manifold Approximation and Projection (UMAP) algorithm.

13. The computer-implemented method of claim 8, wherein the image data is received from an ego vehicle based on sensor data from at least one image sensor positioned at the ego vehicle.

14. The computer-implemented method of claim 8, wherein an object of the first plurality of objects is identified using an annotated object label of an image of the first plurality of images.

15. A non-transitory computer-readable media comprising machine executable instructions stored thereon, which, when executed by at least one processor of a computing device, cause the computing device to:
process a current training dataset, including a first plurality of images, to identify a first plurality of objects;
identify a distribution of a first set of datapoints corresponding to the first plurality of objects in a grid including a plurality of bins;
receive image data including a second plurality of images;
identify a second plurality of objects from an image of the second plurality of images;
identify one or more bins of the plurality of bins associated with a second set of datapoints corresponding to the second plurality of objects;
for each bin of the plurality of bins, compute a respective sampling weight based upon the first set of datapoints and the second set of datapoints;
identify a bin, of the plurality of bins, having the respective sampling weight that satisfies a particular criterion; and
add one or more objects of the second plurality of objects having corresponding datapoints of the second set of datapoints to the bin and add the image from the second plurality of images to the current training dataset, thereby generating an improved training dataset.

16. The non-transitory computer-readable media of claim 15, wherein the respective sampling weight is computed using a formula that generates a lower value of the respective sampling weight for a larger number of datapoints in the first set of datapoints or the second set of datapoints.

17. The non-transitory computer-readable media of claim 15, wherein an object of the second plurality of objects is identified using a two-dimensional object detector algorithm.

18. The non-transitory computer-readable media of claim 15, wherein the machine executable instructions, which, when executed by the at least one processor of a computing device, further cause the computing device to:
identify a bounding box corresponding to an object of the first plurality of objects or the second plurality of objects;
input the bounding box corresponding to the object to a large image foundation model to identify high-dimensional latent space features;
reduce dimensionality of the high-dimensional latent space features using a dimensionality reduction algorithm to two-dimensional features; and
obtain a datapoint corresponding the two-dimensional features of the object,
wherein the dimensionality reduction algorithm includes a t-distributed Stochastic Neighbor Embedding (t-SNE) algorithm or a Uniform Manifold Approximation and Projection (UMAP) algorithm.

19. The non-transitory computer-readable media of claim 15, wherein the image data is received from an ego vehicle based on sensor data from at least one image sensor positioned at the ego vehicle.

20. The non-transitory computer-readable media of claim 15, wherein an object of the first plurality of objects is identified using an annotated object label of an image of the first plurality of images.
